(19) United States
(12) Patent Application Publication
(10) Pub. No.: US 2006/0019001 A1
(43) Pub. Date: Jan. 26, 2006

(54) A MICROWAVE FAT FRYING KIT AND FAT FRYING METHODS

(76) Inventor: Melvin L. Levinson, Edison, NJ (US)

Correspondence Address: Melvin L Levinson, 8 Stratford Circle, Edison, NJ, 08820-1830, US

(21) Appl. No.: 10/908,742

(22) Filed: May 24, 2005

Related U.S. Application Data
(60) Provisional application No. 60/590,625, filed on Jul. 23, 2004.

(51) Int. Cl. A23L 1/01

(52) U.S. Cl. 426/243

(57) ABSTRACT

The invention concerns fat frying methods and a microwave oven kit that provide, as desired, the results top-of-the-range-frying, oven baking, oven broiling, barbequing and conventional deep fat frying. The kit includes a metal, microwave browning pan, a microwave permeable cover and a microwave reflective cover. The methods concern utilizing preselected amounts of oil and different kit configurations to enhance the preparation of pizza pies, fruit pies, coffee beans, soy beans, cakes, bread, bagels, rolls, tortillas, matzos, noodles, steaks, chops, spare ribs, popcorn and frozen convenience TV dinners as well as fried chicken, fish sticks, potato chips, and French fried potatoes. This invention adds to the microwaving and then conventional broiling methods taught in U.S. Pat. No. 5,094,865 and in U.S. Pat. No. 5,057,331.

### BACKGROUND OF THE INVENTION

1. Field of the invention

This invention concerns microwave fat frying methods that yield the results of conventional deep fat fried chicken, fish sticks, potato chips, French fried potatoes, and other deep fat fried foods. It concerns methods for utilizing a microwave oven kit to prepare pizza pies, fruit pies, coffee beans, soy beans, cakes, bread, bagels, rolls, tortillas, matzos, noodles, steaks, chops, spare ribs, potato chips, popcorn and frozen convenience TV dinners. The kit includes a metal, microwave browning pan, a microwave permeable cover and a microwave reflective cover that, in operation, yield the results of top-of-the-range frying, oven baking, oven broiling, barbequing and conventional deep fat frying.

2. Description of the Prior Art

Deep fat frying, per se, is described in, “Gourmet's, Basic French Cookbook,” Louis Diat, Gourmet Distributing Corporation, NY, N.Y., 1961, pages 216-227. In conventional deep fat frying, oil covers a food in a container, an external heat source heats the container and the hot container heats the oil. The hot oil heats the outside of a foodstuff and the hot outside of the foodstuff heats the inside of the foodstuff. In contrast, in microwave cooking, microwaves selectively heat both the outside and the inside of a foodstuff when immersed in a container of oil.

Microwave deep fat frying, prior 1990, is detailed in the “Background” of U.S. Pat. No. 5,144,106. U.S. Pat. No. 5,144,106 teaches to deep fat fry French fried potatoes in oil in a glass or ceramic container in a microwave oven. Microwave deep fat frying, in plastic, glass and ceramic containers, is dangerous as plastic, glass and ceramic containers are fragile and they can shatter spilling circa 400° F. hot oil.

U.S. Pat. No. 3,941,967 teaches microwave browning pan construction, a metal microwave browning pan cover with microwave transparent portions designed to permit the microwave irradiation of selected portions of a foodstuff heated there under and, to prevent sparks in microwave cooking, it teaches means to connect a metal cover to a metal cooking surface.

U.S. Pat. No. 4,390,555 teaches to surface-defrost-wet frozen foodstuff and to selectively wet frozen TV dinners prior to exposing them to microwave energy. U.S. Pat. No. 5,736,718 teaches to place between two metal plates a slice of bread to enhance the crusting of the slice of bread. U.S. Pat. No. 4,580,024 teaches to irradiate with microwaves a foodstuff while it is frying in a conventional deep fat fryer. U.S. Pat. No. 6,231,909 teaches to microwave-roast, without a microwave lossy heating element, green coffee beans, soy beans, and rice in oil in a glass or ceramic container. U.S. Pat. Nos. 5,045,660, 4,923,704, 4,906,806 and 4,390,554 teach that conventional, deep-fat frying can be effectively simulated by applying a small quantity of cooking oil to a convenience frozen prefried food to replace oil which is driven off during microwave heating. U.S. Pat. No. 5,094,865 and in U.S. Pat. No. 5,057,331 teach to first microwave and then conventionally broil selected foodstuffs.

### SUMMARY OF THE INVENTION

The invention teaches methods of using a microwave oven kit that comprises a metal microwave browning pan, a mating microwave permeable cover and a mating microwave impermeable cover. The covers can be flat or domed and solid or perforated. The kit can include both conventional metal and aluminum foil pizza, two crust pie, cake, and bread pans. The kit can include a microwave browning pan strainer basket and it can include detachable microwave browning pan handles. In operation a foodstuff is microwaved in a microwave browning pan that contains a predetermined amount of oil or in a metal container that is placed in the predetermined amount oil that is in the microwave browning pan. The oil is heated to at least the browning temperature of a conventionally deep fat fryer but below the smoke and flash point of the oil. During or after microwaving, if desired, the foodstuff can be inverted. After microwaving the foodstuff can be broiled under a conventional infrared broiler.

It is an object of this invention to teach methods of utilizing a microwave oven kit that consists of a metal, microwave browning pan, a microwave permeable cover and a microwave impermeable cover.

It is an object of this invention to add to the thermal capacity of a metal, microwave browning pan by preheating, at least, two ounces of oil therein.

It is an object of this invention to teach microwave cooking methods that yield foodstuff with the taste and appearance of a conventional deep fat fried food.

It is an object of this invention to teach a microwave cooking method that combines the results of microwave fat frying with the results of conventional infrared broiling to yield a foodstuff similar in taste and appearance of a conventional deep fat fried food.

It is an object of this invention to teach methods that enhance the microwave preparation of pies, cakes, bread, bagels, rolls, tortillas, matzos, noodles, potato chips and popcorn.

It is an object of this invention to teach methods that enhance the microwave preparation of meat loaves, steaks, chops, spare ribs and the like.

It is an object of this invention to teach a method for improving the browning of the bottom crust of pies, cakes, bread and the like when they are microwaved in conventional metal pie, cake and bread pans in oil on a microwave browning pan.

It is an object of this invention to add to the methods taught in U.S. Pat. Nos. 5,094,865 and 5,057,331.

It is an object of this invention to teach microwave cooking methods that yield the flavor, taste and appearance of conventional deep fat fried chicken, fish sticks, potato chips, French fried potatoes, and other normally deep fat fried foods.

It is an object of this invention to teach methods that enhance the microwave preparation of certain frozen convenience foods and frozen TV dinners.

It is an object of this invention to teach a method for microwave roasting green coffee beans, soy beans, rice in oil in a metal, microwave browning pan.

And, it is an object of this invention to teach apparatus and methods for achieving, when desired, conventional oven, top-of-the-range and broiler results and, when desired, deep-fat-frying results in a domestic microwave oven. This is especially useful in small apartments, small mobile homes, small pleasure boats that employ a countertop microwave oven as their sole means of cooking.

### DESCRIPTION OF THE DRAWINGS

The advantages and benefits that result when one uses the microwave kit will become apparent from the following detailed description and by reference to the accompanying drawings in which:

FIG. 1 illustrates a metal, microwave browning pan containing a foodstuff immersed in oil under a conventional broiler.

FIG. 2 illustrates a metal, microwave browning pan, covered by a mating metal, glass, paper or plastic cover, that contain a foodstuff immersed in oil.

FIG. 3 illustrates an inner metal pan containing foodstuff that is floating on a layer of oil within a microwave browning pan. The assembly is covered by a dome cover. The microwave browning pan is supported on a microwave non-lossy, heat-insulating receptacle. The dome cover and mating microwave non-lossy receptacle define a cooking chamber.

FIG. 4 illustrates a metal, microwave browning pan covered by a mating glass, paper or metal cover. Pictured in the pan is a deep-fat-fryer type basket containing a foodstuff immersed in oil.

FIG. 5 illustrates, after it was removed from the microwave browning pan, the deep-fat-fryer type basket containing the foodstuff, illustrated in FIG. 4, resting on a broiler shelf under a conventional broiler.

FIG. 6 illustrates a microwave browning pan containing, a conventional, convenience TV dinner, packaged in its ovenable metal, paper or plastic container, floating on a layer of oil.

FIG. 7 illustrates a microwave browning pan and a cover containing a flat foodstuff immersed in oil. The flat surface of the foodstuff is held in direct contact with the food receiving surface of the browning pan by a weight.

FIG. 8 illustrates a microwave browning pan containing oil holding a covered aluminum foil container that has popcorn kernels therein.

### DESCRIPTION OF THE PREFERRED EMBODIMENTS

There follows ways to use a microwave oven kit that comprises a metal microwave browning pan, a microwave permeable cover and a microwave impermeable cover. The kit is designed to provided a cook with means to achieve the results of top-of-the-range frying, deep-fat-frying, oven baking, oven broiling and barbequing in a conventional countertop microwave oven.

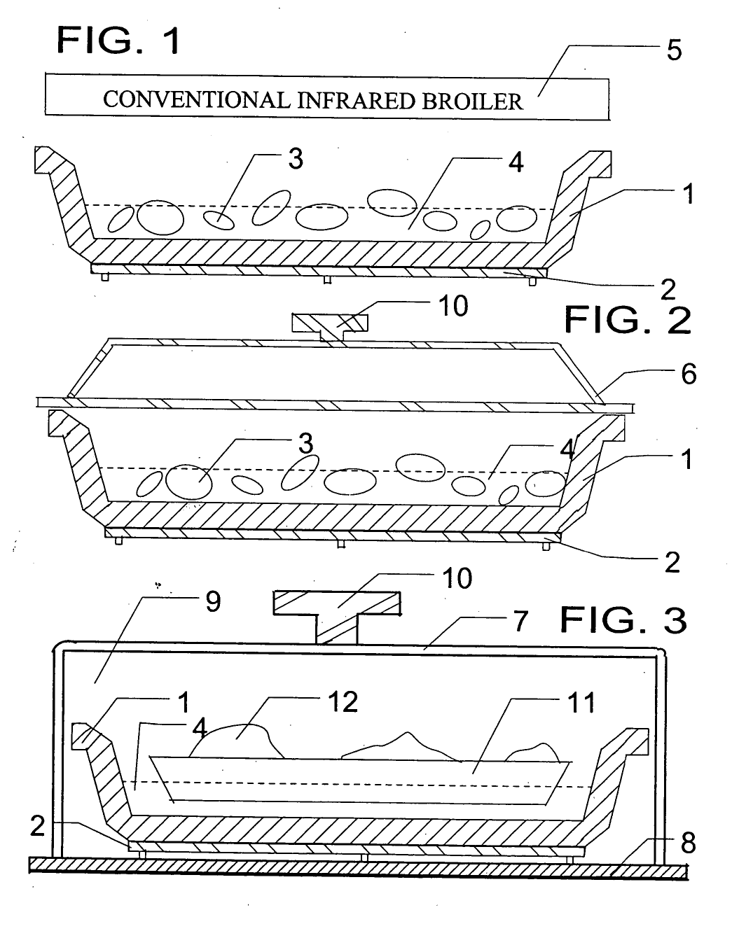

In FIG. 1, a metal, microwave browning pan 1, with a conventional microwave heating member 2, containing frying oil 4 is preheated in a microwave oven. Foodstuff 3 is added and the assembly is heated in the microwave oven for a predetermined time. If desired, pan 1 and microwaved foodstuff 3 can be removed from the microwave oven and broiled under conventional infrared broiler 5. If desired, pan 1 and microwave foodstuff 3 are drained of frying oil 4 before broiling under conventional infrared broiler 5.

In FIG. 2 and in FIG. 3, 1) to prevent the cool air, that is normally blown through a microwave cooking cavity, from cooling foodstuff 3, 2) to permit a build up of heat there under and 3) to contain splatter, paper, glass, ceramic or metal cover 6 or dome cover 7 is provided. Cover 6 is designed to mate with microwave browning pan 1. When cover 6 is metal, it is fabricated to shield foodstuff 3 from direct exposure to microwave radiation. When desired, metal cover 6 can include a microwave permeable opening (not shown) to allow some microwave energy to heat foodstuff 3.

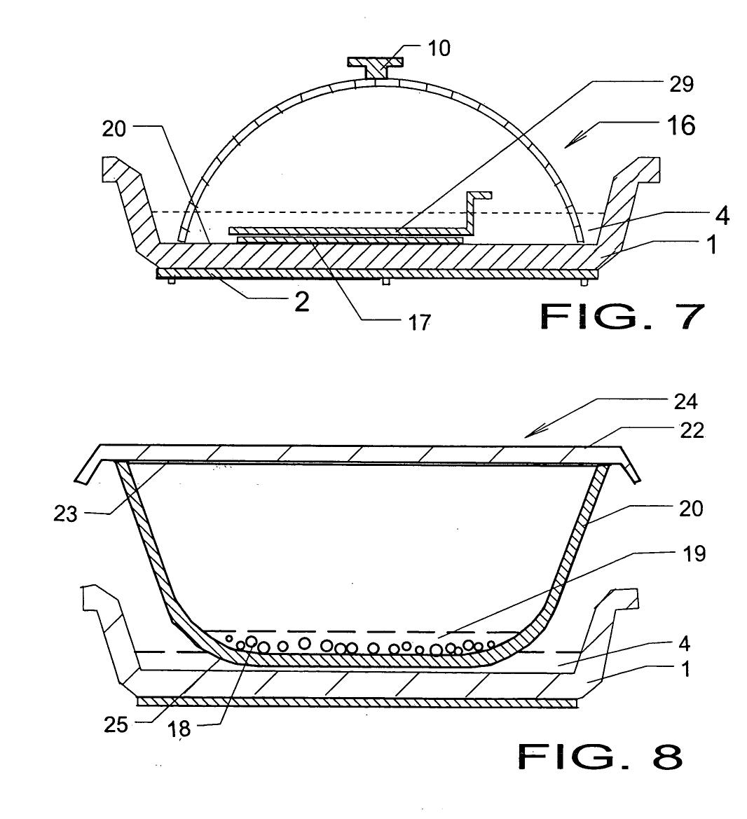

In FIG. 7, cover 16 is an inverted conventional metal strainer cover 16 resting in frying oil 4 inside metal microwave browning pan 1 and covering and shielding foodstuff 3 from direct exposure to microwave radiation. Note, frying oil 4 prevents arcing between metal strainer cover 16 and the metal microwave browning pan 1. The cook can monitor heating foodstuff 17 through the perforations in metal strainer cover 16. Steam, emitted from heating foodstuff 17 passes unimpeded through metal strainer cover 16 and is removed by the microwave oven fan. After microwaving, metal strainer cover 16 can be inverted and used to drain off oil 4 from microwaved foodstuff 3. If it is desirable to contain the steam released from the heating foodstuff 17, a second non-perforated, transparent cover 7 can be employed to cover, as shown in FIG. 3, perforated cover 16.

In FIG. 3, metal microwave browning pan 1 is supplied with a heat-insulating, non-lossy, support 8 that mates with dome cover 7 to form an oven chamber 9. Both cover 5 and dome cover 7 preferably have conventional means 10 to facilitate their placement and removal. In FIG. 3, floating on frying oil 4, is heat conductive inner pan 11 containing a foodstuff 12. Inner pan 11 may be metal and foodstuff 12 may be fried eggs, ham, bacon, convenience French fries and the like. Inner pan 11 may be a conventional frying pan, pizza pan, two-crust pie pan, cake pan, bread pan and the like. If desired, more than one inner pan 11, side by side (not shown), can be utilized. Note, frying oil 4 prevents arcing between inner pan 11 and the metal microwave browning pan 1.

In FIG. 3, in a representative operation, while outside a microwave oven, biscuit batter 12 is being prepared in inner pan 11, microwave browning pan 1 containing frying oil 4 is preheated in the microwave oven to circa 400° F. Then the prepared biscuit batter 12 in inner pan 11 is placed in the preheated hot frying oil 4 and the assembly is exposed to microwave energy until the biscuits are baked. If one desires a brown top crust, dome cover 7 is removed and the microwave baked biscuits are crusted and browned under a conventional infrared broiler. This operation is the same as taught in my U.S. Pat. No. 5,094,865's “Two Stage Process for Cooking-Browning-Crusting Food in a Microwave Oven” except that the bottom browning of the biscuits are enhanced by the heat released from preheated frying oil 4. It should be understood that pie in a metal pie pan, cake in a metal cake pan, bread in a metal bread pan can be prepared in the same manner as the biscuits. It is expected that some will microwave well known biscuit dough sold in packaged tubes, and some will center a hole in each biscuit's dough so that when the microwave baked biscuits are crusted and browned under a conventional infrared broiler the “biscuits” resembles bagels.

In FIG. 2, in operation, fried chicken, fish sticks, potato chips, French fried potatoes, and other normally deep fat fried foodstuff 3 are placed into oil 4 in microwave browning pan 1 and microwaved to circa 475° F. If desired oil 4 in pan 1 can be preheated before foodstuff 3 is placed therein. Cover 6 may be microwave permeable or microwave impermeable. If foodstuff 3 is frozen or dense, first foodstuff 3 is microwaved under a microwave permeable cover until frozen foodstuff 3 defrosts and heats and then the microwave permeable cover is replaced with a microwave impermeable cover that prevents microwave energy from reaching foodstuff 3 so that the full force of the microwave energy raise the temperature of oil 4 to just below its smoke point. A microwave impermeable covered metal browning pan can be characterized as a “covered microwave powered deep fat fryer.” If desired, the microwave fat fried foodstuff 3, as shown in FIG. 1, can be exposed to a conventional infrared broiler 5.

In FIG. 2, in operation, foodstuff 3, as green coffee beans, soy beans, rice and similar grains and seeds, is immersed in oil 4 in covered microwave browning pan 1 and microwave roasted. As taught in my U.S. Pat. No. 6,231,909, one microwave roasts the green coffee beans, soy beans, rice and similar grains and seeds until a preselected color is visible through transparent cover 6. For example, one microwave roasts green coffee beans until the color of an American, a French, or an Espresso coffee roast is achieved.

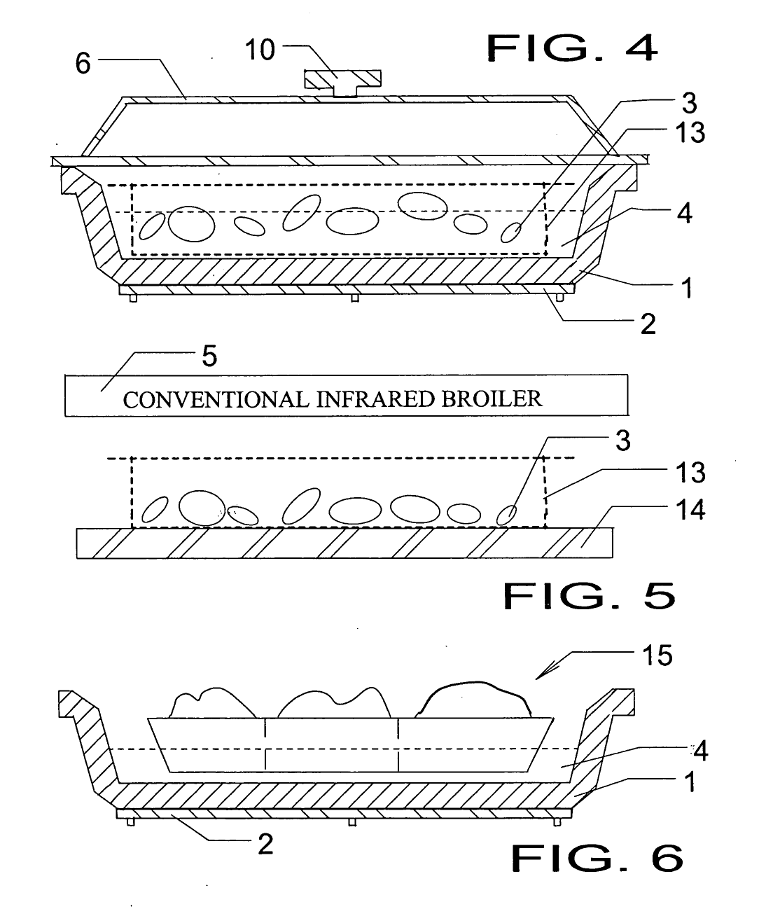

In FIG. 4, in operation, cover 6, microwave browning pan 1, foodstuff 3 in deep-fat-fryer-type wire basket 13 and frying oil 4 are assembled and exposed to microwave energy. Thereafter, cover 6 is removed and foodstuff 3 in wire basket 13 is removed from microwave browning pan land drained. If desired, as illustrated in FIG. 5, foodstuff 3, in wire basket 13 on broiler shelf 14, is broiled under conventional infrared broiler 5.

In FIG. 4, in operation, a raw potato is thinly sliced and each slice is immersed in oil 4 in strainer 13 in microwave browning pan 1 and the assembly is covered with transparent microwave permeable cover 6. The assembly is exposed to microwave energy until the slices of potato, as viewed through cover 6, microwave fry to a predetermined brown color. The microwaved potato chips, foodstuff 3, are lifted by strainer 13 out of oil 3, shaken and drained. In operation, the raw slices of potato are one thick layer with oil 3 just covering the thick layer. During the exposure to microwave energy the microwave energy evaporates the majority of the water (liquid) component of the potato slices and browns the potato slices. The thick layer of browned potato chips easily separate. Surprisingly, the microwave heated interior, on cooling, removes excess oil from the surface of the potato chips resulting in crispy flavorful chips.

In FIG. 6, in operation, frying oil 4 is preheated to circa 400° F. in covered browning pan 1. Then conventional frozen TV dinner 15 in its ovenable container is placed (floating or resting) in the circa 400° F. frying oil 4. The assembly is exposed to microwave energy until conventional frozen TV dinner 15 is heated to a predetermine temperature. If desired, the microwaved conventional frozen TV dinner 15 is removed from the assembly, placed on broiler shelf 14 and broiled under conventional infrared broiler 5. The manufacturer's directions to remove selected portions of the plastic film found on conventional frozen TV dinners must not be followed and in their place 1) remove all of the plastic film and 2) surface-defrost-wet the frozen TV dinner as taught in my U.S. Pat. No. 4,390,555. Only certain conventional frozen TV dinners as those containing fried chicken, fried fish, French fried potatoes and the like will benefit by being microwaved in preheated oil and then broiled as described.

It is expected, that when the ease and utility of the microwave preparation of conventional frozen TV dinners, taught herein, becomes apparent, new frozen TV dinners designed to benefit from the top and bottom browning and crusting, taught herein, will be marketed in aluminum foil containers. The present ovenable plastic and paper containers, designed for use in conventional 400° F. ovens, are not damaged immersed in preheated 400° F. frying oil 4. After microwaving the conventional frozen TV dinner packaged in ovenable plastic and paper containers is broiled under a conventional infrared broiler and visually monitored while the dinner browns and crusts. Under the conventional infrared broiler the surface of the food browns before the ovenable plastic and paper container sustains serious damage.

A shallow, wide, open, metal, microwave browning pan, fabricated as is “The Microbake Crisping Pan,” manufactured and sold on QVC by Waveware Limited, Templemichael Business Park, Longford, Ireland, provides excellent results. The Waveware pan is designed to operate under a conventional infrared broiler. Waveware's browning pan is capable of efficiently and swiftly heating to temperatures above the smoking point (circa 475° F.) of frying oil. Waveware teaches to preheat its browning pan no longer than 1½ minutes in a 1000 watt microwave oven.

Prior art teaches to heat a conventional deep fat fryer apparatus to circa 375° F. Here it is taught to add, preferably, 6 ounces of frying oil to a Waveware type microwave browning pan and then preheat the Waveware type microwave browning pan and oil for circa 5 minutes until the oil reaches circa 450° F. (e. g., a temperature just below the smoke temperature of the oil). Said another way, the invention teaches to enhance the browning ability of a Waveware type microwave browning pan designed to be preheated for 1½ minutes by adding, at least, 2 ounces of oil and preheating it, for at least, 3 minutes to increase its thermal browning capacity.

Since 1992, Whirlpool Corporation has been selling metal microwave browning pans for use in their microwave ovens. All are suitable for use as taught herein. Whirlpool's 2 inch high×8½ inch diameter microwave browning pan, when covered with a microwave permeable or a microwave impermeable cover, is preferred for, when a foodstuff is placed in hot oil therein, its 2 inch high sidewalls confine splatter when the cover is removed during and after microwaving. In a representative example of its use, 4 ounces of oil are preheated in domestic 1,000 watt microwave oven. A Banquet frozen 7 ounce chicken pie in its aluminum foil pie plate is placed in the preheated oil in the 2 inch high Whirlpool browning pan and covered with a Pyrex® cover. The assembly is exposed to microwave energy for seven minutes. If additional top browning is desired, the Pyrex® cover is removed and the microwaved chicken pie still in the Whirlpool browning pan is exposed to infra red radiation from the broiler element of a preheated toaster oven until a predetermined additional top browning occurs. The preheated hot oil adequately browns the bottom and side crusts. This contrasts to Banquet's direction that teach to perform the unnecessary step of cutting a slit in the top crust and preheating a conventional oven (circa 10 minutes) to 400° F. and then baking the frozen pie in the oven for 30 to 35 minutes.

In prior art microwave cooking, spotty and uneven heating occurs when an irregular bottom surface of a foodstuff contacts the flat surface of a browning pan. Advantageously, when a foodstuff is placed in oil, as taught herein, the hot oil collects heat from all parts of the metal microwave browning pan and evenly heats the irregular surfaces of the foodstuff it contacts. When microwaved in oil, for a predetermined time, in a metal microwave browning pan, covered with a microwave impermeable cover, roasts, steaks, ribs and lamb chops appear in taste and appearance barbecued.

Not illustrated, well known detachable handles are available to transport microwave browning pans to and from a microwave oven. Not illustrated, additional foodstuff can be defrosted and heated while resting on top of a hot microwave browning pan cover during an exposure to microwave energy. For example, just before two hot dogs finish browning in a covered microwave browning pan, two frozen hot dog rolls are placed on the hot cover and there the hot dog rolls defrost and heat while the two hot dogs finish browning.

To speed heating and for ease in cleanup, preferably, inner pan 11 and wire basket 13 are low mass, disposable, aluminum foil containers. In operation, for example, French fried potatoes foodstuff 3 in aluminum foil wire basket 13 are immersed in oil 4 and fat fried in microwave browning pan 1. Then, if desired, the fried potatoes in wire basket 13 are removed and placed into a mating deep-well, aluminum foil non perforated basket (not shown) and broiled under a conventional broiler. Excess oil, which is broiled off the microwaved fried potatoes, falls through the perforations and collects in the mating deep-well aluminum foil non perforated basket as taught in U.S. Pat. No. 5,057,331. Conventional, disposable, aluminum foil cooking containers are available in multi shapes and sizes.

In FIG. 7, in operation, a flat foodstuff 17, for example, a thin steak, a tortillas, a slice of bread, a convenience waffle, a matzo, a bagel, a convenience pretzel and the like, can be held in direct contact with hot food contacting surface 26 of browning pan 1 by weight 29, metal screen 13, or a light transparent borosilicate dish. Foodstuff 17 immersed in hot oil 4 and flattened by weight 29 and shielded by metal screen cover 16 is exposed to microwave energy for a predetermined time. For example, if foodstuff 17 is a slice of frozen rye bread, the cook may choose to use two ounces of oil and toast only one side of the bread under weight 29 covered by a microwave transparent cover 16. As taught in U.S. Pat. No. 5,736,718, if weight 29 is a metal plate, when finished the bread crust will taste like it was a just baked crust. The toasted side of the bread will be flavored with polyunsaturated tasty oil and not require a saturated oil as butter.

Note, some thin steaks and some tortillas curl when heated in hot oil. Weight 29 keeps them flat. A thin refrigerated steak quickly “broils” and turns “well done.” Frozen thick steaks, hamburgers and the like that are “broiled” in hot oil and shielded from direct exposure to microwave energy by microwave impermeable cover 6 turn out “rare” and “medium rare.” After microwave fat frying in a microwave impermeable covered chamber, if a rare steak or hamburger is not desired, direct exposure to microwave energy will swiftly turn the rare steak or hamburger into a well done steak or hamburger.

In FIG. 8, in operation, circa four ounces of popcorn kernels 18 and, if desired, a non saturated oil or butter 19 are placed in a low mass, disposable, aluminum-foil container 20 covered with flat cover 24. Container 20 containing the popcorn kernels 18 is placed in oil 4 and the assembly is exposed to microwave energy until the popcorn kernels 18 pop filling container 20. Thereafter, flat cover 24 is removed and inverted and container 20 containing the popped popcorn is placed thereon and served. Note, during popping oil splatters surface 23 of cover 24 and the bottom surface 25 of container 20 is covered with oil. It follows that, when container 20 is placed on inverted flat cover 24, the two oily surfaces 23 and 25 contact each other and the inverted base 22 of cover 24, free of oil, shields the surface receiving the popped popcorn from being soiled with oil.

The cook chooses the amount and type of food, the amount of oil, the amount of preheating time, and the amount of microwave exposure to achieve a desired result. The cook chooses whether to use a microwave reflective or a microwave permeable cover or the sequential use of the microwave reflective and the microwave permeable cover. Just cooked hot food is easily drained of excess or unwanted oil, but, if the food is allowed to cool before excess or unwanted oil is removed, the oil is less free flowing.

This invention teaches apparatus and methods for achieving, in a conventional microwave oven, the flavor, color and appearance of top-of-the-range frying, oven baking, infrared broiling and conventional deep fat frying. This ability to duplicate the results of conventional cooking in a microwave oven is especially useful in small apartments, small mobile homes, small pleasure boats and the like that employ a countertop microwave oven as their sole means of cooking.

Although this invention has been described with a certain degree of particularity, it is understood that the present disclosure has been made by way of example and that numerous changes in details of construction and arrangement of parts may be resorted to without departing from the spirit and scope of the invention

What is claimed is:

1. A microwave oven method the steps that include:
exposing to microwave energy a metal, microwave browning pan containing, at least, two ounces of a frying oil and a foodstuff until the oil heats to the frying temperature of said foodstuff, and then, when said foodstuff reaches a predetermined temperature, exposing said foodstuff to infrared energy from a conventional infrared broiler.

2. The method according to claim 1, where said foodstuff is a frozen TV convenience dinner.

3. The method according to claim 1, the added step of
where said foodstuff is in a metal pan, locating said foodstuff in said metal pan into said microwave browning pan.

4. The method according to claim 3 that includes the added step of adding, at least, one ounce of oil to said metal pan.

5. The method according to claim 3 where said metal pan is aluminum foil.

6. The method according to claim 3 where said foodstuff is popcorn kernels.

7. The method according to claim 3 where said metal pan is perforated.

8. A microwave oven method that comprises:
exposing to microwave energy a metal, microwave browning pan containing, at least, four ounces of frying oil and a foodstuff therein until said selected foodstuff reaches a predetermined temperature.

9. The method according to claim 8, the added step of exposing said heated foodstuff to infrared energy from a conventional infrared broiler.

10. The method according to claim 8 that includes the added step of,
during said exposure to microwave energy, covering the foodstuff with a microwave reflective cover that shields said foodstuff from exposure to microwave energy.

11. The method according to claim 8 that includes the added step of,
during said exposure to microwave energy, covering the metal, microwave browning pan with a microwave permeable cover to define an enclosed cooking chamber.

12. The method according to claim 8, wherein said metal, microwave browning pan containing said, at least, four ounces of frying oil is preheated before adding said foodstuff.

13. The method according to claim 8, wherein said foodstuff is selected from a group consisting of fried chicken, fish sticks, thin potato slices, French fried potato pieces, egg rolls, and pizza rolls.

14. The method according to claim 8, wherein said foodstuff is selected from a group consisting of a pizza pie in a conventional metal pizza pie pan, a two-crust pie in a conventional metal two-crust pie pan, a cake in a conventional metal cake pan and bread in a conventional metal bread pan.

15. A kit for use in a microwave oven that comprises:
a metal microwave browning pan,
a mating microwave permeable cover,
a mating microwave impermeable cover, and
a strainer basket for use in said browning pan.
